(19) United States
(12) Patent Application Publication
(10) Pub. No.: US 2004/0261581 A1
(43) Pub. Date: Dec. 30, 2004

(54) Champagne or sparkling beverage bottle opener

(76) Inventors: Geraldine Annette Merrick, Parowan, UT (US); Phillip Michael Van Deventer, Parowan, UT (US)

Correspondence Address: Geraldine Annette Merrick, P.O. Box 1150, 1214 W. Hwy 91, Parowan, UT, 84761-1150, US

(21) Appl. No.: 10/609,467

(22) Filed: Jun. 30, 2003

(51) Int. Cl. B25B 17/00

(52) U.S. Cl. 81/3.55

(57) ABSTRACT

The present new and improved invention designed to open Champagne and Sparkling Beverage bottles sealed with modern plastic stoppers is a one piece bottle opener with no movable parts. This invention is designed to fit comfortably in the palm of the hand. By securing the ring on the opener over the stopper top and the lower jaw of the opener under the bottom edge of the stopper, a consumer can easily and safely lift the stopper out of the bottle. The gas in these beverages can be released slowly and safely with this opener. By lifting up on the handle, the stopper is gently pulled up and out of the bottle without the usual past sudden explosion of gas and beverage spillage. Safety and ease in opening these bottles sealed with plastic stoppers is the purpose of this new and improved bottle opener.

### CROSS-REFERENCE TO RELATED APPLICATIONS

Non-Applicable

### STATEMENT REGARDING FEDERALLY SPONSORED RESEARCH OR DEVELOPMENT

Non-Applicable

### REFERENCE TO A MICROFICHE APPENDIX

Non-Applicable

### BACKGROUND OF THE INVENTION

The present invention relates to the field of bottle opener manufacturing, and in particular to a method of opening Champagne or Sparkling Beverage bottles sealed with modern plastic stoppers.

The present invention arose from an attempt to develop a method of safely and simply opening these types of beverages that are pressurized and sealed with modern plastic stoppers instead of the traditional wooden corks.

The Champagne and Sparkling Beverage industry are using the plastic stoppers more and more because they are less costly and more durable in shipping. They are also sterile and protect the beverage quality. Leakage has also been a problem with the traditional wooden corks.

The plastic stoppers are an advantage for the beverage producer, but the consumer has been left with a challenge. The stoppers are almost impossible to pull from the bottles by hand. The present invention makes opening these types of beverages very safe and easy. The present invention will add great confidence to the consumer and should help to increase the sales volume of Champagne and Sparkling Beverages sealed with plastic stoppers.

### BRIEF SUMMARY OF THE INVENTION

The present invention solves the challenge of opening a bottle of a pressurized beverage sealed with a plastic stopper. This present bottle opener invention is easily used by anyone whether they are right or left-handed. Great strength is not needed in the hand or the wrist. Stress on the thumbs is totally reduced by using this new opener invention.

The present invention is a new and useful bottle opener. The ring on the opener fits on top of the plastic stopper. The curved jaw of the opener fits between the lower edge of the stopper and the top of the bottle opening. By gently lifting up on the opener handle, which is comfortable in the palm of the hand, the gas in the bottle is slowly and safely released. A person can choose to reposition the opener around the plastic stopper more than one time in order to release all of the gas pressure inside the bottle. The plastic stopper can then be easily lifted up and out of the bottle. By using this present invention bottle opener correctly, there is no sudden explosion of gas with the stopper coming out of the bottle. There is no messy beverage foaming up and out of the bottle. The bottle is easily and safely opened without anxiety or fear for the consumer. The bottle should be well chilled according to the manufacturer's instructions before attempting to open.

The present bottle opener invention is manufactured in one piece and has no moving parts. The materials used for manufacturing can be stainless steel or injected plastic mold material.

The present invention takes very little instruction to use correctly for the first time. It will fit in a drawer, can also be hung on the wall or displayed on a counter.

This new bottle opener invention will be a great benefit to this type of worldwide beverage industry. Customers will have an increased confidence opening these types of of beverages. Professional bartenders and waiters will also benefit from this new invention.

### BRIEF DESCRIPTION OF THE DRAWINGS

FIG. 1A is a top plan full view of the bottle opener invention. This drawing shows the round ring and handle and edge of the lower jaw that fits under a plastic stopper.

FIG. 2A is an under plan view of the bottle opener invention. This drawing shows the ring and concaved handle and lower jaw that fits under a plastic stopper and the bottle.

FIG. 3A is a plan side view of the bottle opener invention.

Please Note: Left and right side are identical in dimension and design.

FIG. 4A is a close-up bottom view of the lower jaw of the bottle opener invention

### DETAILED DESCRIPTION OF THE INVENTION

The present invention is a new and improved bottle opener for both Champagne and Sparkling Beverages sealed under pressure with modern plastic stoppers. These types of plastic stoppers are replacing the traditional wooden or natural corks used in this bottling industry. They are an advantage and improvement for the wine and beverage merchants for sealing their bottles, but the consumer has been left with a great challenge. The plastic stoppers are extremely difficult to remove. Great stress is put on the thumbs and other joints in the hand. There are also dangers of plastic stoppers suddenly exploding from the pressurized beverage bottles. The pains, fears and dangers of opening these types of bottles have caused much anxiety with consumers.

This present new and improved invention addresses these concerns of this market. As consumers gain confidence in the easy and safe removal of the modern plastic stoppers from various Champagne and Sparkling Beverage bottles, the increase sales in this particular industry should be a great benefit in the worldwide economy.

The present invention is a simple bottle opener designed for the purpose of removing the plastic stoppers with greater ease and safety. The tool is light weight and has no moving parts. It is designed to fit comfortably in the hand. Anyone can use it whether they are left or right handed. No detailed instructions are needed for using the bottle opener. This new and improved bottle opener does not take much strength or skill to use.

Manufacturing materials can be in the lost wax process for 300 Series Stainless Steel or the various injection mold plastic type materials. The opener is designed to have a balance of strength, weight and comfort in these economical materials. Final finishes can be polished or even produced in several colors. Packaging for the worldwide market can anything from bubble wrap paperboard to more formal boxes with separate storage sacks or pouches for a luxury gift type item.

The new improved bottle opener is a comfortable size with an Art Deco flare design. Dimensions are as follows: Opener Full Length: 6¼″

Full Handle Width is from 1″ flaring to 1½″ (formed to the consumer's palm of hand)

Thickness of the Opener Ring: ⅜″

Opener Ring inside Diameter: 1″

Opener Ring Outside Dimension: 1⅞″

Opener Thickness Overall: ¼″

Lower Opener Jaw Length: 1⅛″

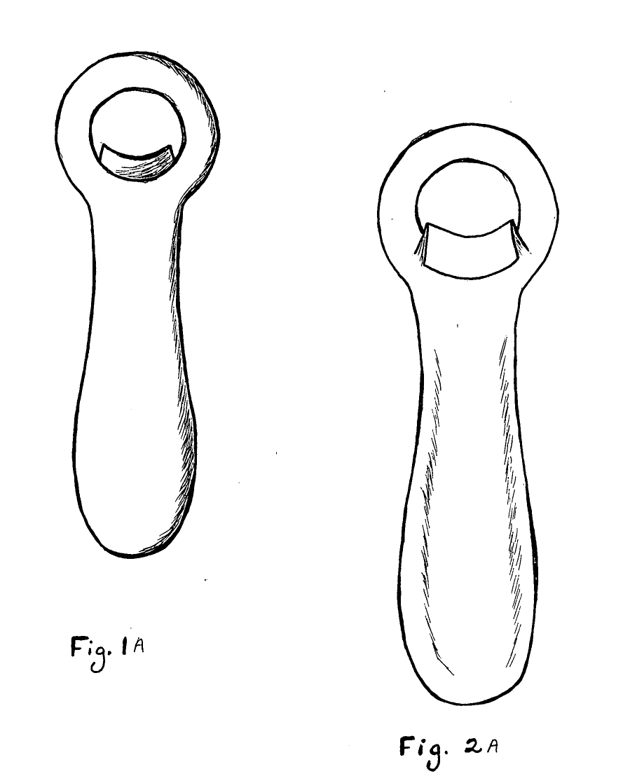

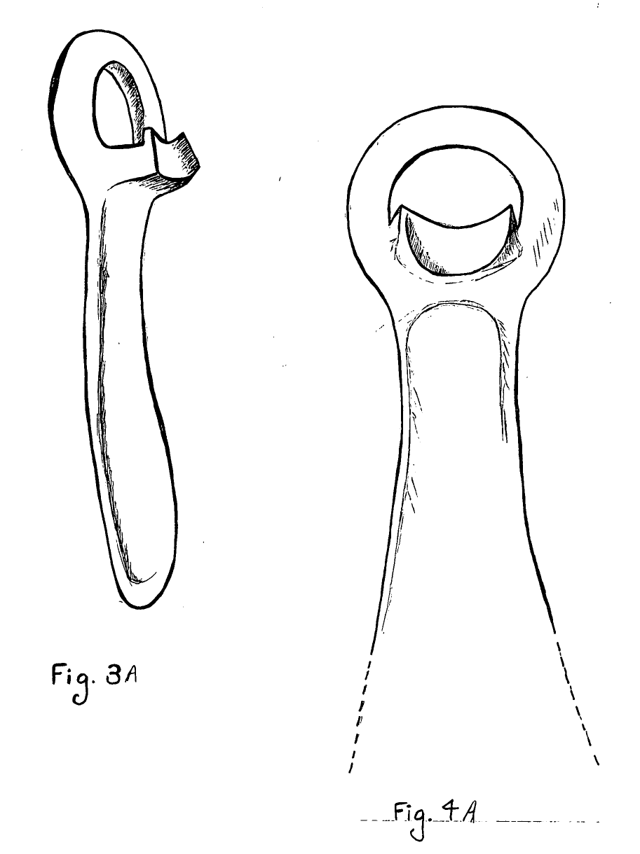

Drawings in the 1 and 2 pages of the bottle opener drawings show the various views of this simple and unique tool. FIG. 1A shows the full top plan view of the opener with the lower jaw showing through the ring. FIG. 2A shows the under plan view of the opener which shows the concaved handle (for comfort and weight reduction) and lower jaw which attaches to the bottom edge of a plastic bottle stopper. FIG. 3A shows a side full view of the bottle opener. Note: Both right and left side views are identical FIG. 4A shows a close up view of the lower jaw and ring detail of the bottle opener . . . all the present new and improved bottle opener is one piece.

The present bottle opener invention is a light weight design bottle opener to appeal to all types of markets worldwide. Packaging and shipping costs will be very economical. No moving parts is also a very attractive feature. The strength in the entire opener tool design and dimensions makes this new invention an improvement in the attempt to open these types of pressurized beverages with plastic stoppers. The bottles should be well chilled according to the manufactures' instructions and warnings on the labels before attempting to open with any method.

The present new and improved bottle opener invention can be stored in a drawer, hung on a hook by the opener ring or displayed on a counter top. With no moving parts, this opener invention can be easily washed and sterilized.

The new and improved design of this bottle opener makes releasing the pressurized gas from Champagnes and Sparkling Beverages easy and safe. The ring on the head or end of the bottle opener fits over the top of the modern plastic stopper of the Champagne or Sparkling Beverage bottle. The lower jaw as referred to fits securely under the lower edge of the plastic stopper. By lifting up on the handle, the consumer can slowly release the gas within the bottle. The user can also choose to reposition the opener jaw several times under the plastic stopper edge and release the gas fully. This makes the stopper very easy to remove without the typical “champagne explosion” that has brought so much fear, injury, dread and anxiety to the industry of pressurized beverages of this type.

Again, the bottle and contents should be well chilled according to the manufacturer's label instructions and warnings on all Champagne and Sparkling Beverage bottles. This new and improved bottle opener is only designed to open bottle sealed with the modern plastic stoppers . . . not natural traditional wooden corks.

1. What we (Geraldine Annette Merrick and Phillip Michael Van Deventer as both Residents of Utah and Citizens of the United States of America) claim as our original and present invention is a Champagne and Sparkling Beverage Bottle Opener made especially to open by leverage these types of pressurized beverages sealed with plastic stoppers.
